(19) United States
(12) Patent Application Publication
(10) Pub. No.: US 2010/0114917 A1
(43) Pub. Date: May 6, 2010

(54) METHODS AND SYSTEMS FOR SCREENING OF PRODUCTS

(76) Inventors: Brian Austin, Portland, OR (US); Tim Dore, Wilsonville, OR (US); Marilyn Johnson, Bellevue, WA (US); Mark Wysong, Lake Oswego, OR (US)

Correspondence Address: Schwabe Williamson & Wyatt;PACWEST CENTER, SUITE 1900, 1211 SW FIFTH AVENUE, PORTLAND, OR, 97204, US

(21) Appl. No.: 12/264,025

(22) Filed: Nov. 3, 2008

(51) Int. Cl. G06F 17/30; G06F 7/00

(52) U.S. Cl. 707/754; 707/E17.032

(57) ABSTRACT

Embodiments of the present invention provide methods and systems for screening of products, especially those with ingredients that may be toxic and/or otherwise harmful to people, animals and the environment in general.

### TECHNICAL FIELD

Embodiments of the present invention relate to the field of materials management, and more particularly, to methods and apparatus for screening of products.

### BACKGROUND

Many companies have potentially hazardous materials (PHM) in their various inventories for various uses including, but not limited to, the development, manufacturing and distribution of their products. Such companies include, but are not limited to, semiconductor, electronic, automotive, consumer product and refining companies. Additionally, many companies may have duplicate types of PHM for similar uses. For example, companies may have numerous types of adhesives, cleaners, disinfectants, etc., many of which are potentially hazardous due to their inherent hazard characteristics and toxicity levels.

While many companies have general procurement departments for purchasing most PHM for use at the company, “smaller” purchases at individual company sites are often made. Such purchases are generally beneath the procurement department's radar. Thus, as much as 80-95 percent of many companies' materials, especially PHM, may be purchased indirectly. Additionally, many companies may have numerous PHM for the same purpose and out of the procurement department's control, especially in light of the “smaller” purchases. This may result in high dollar inventory, as well as use and accumulation of high hazard products to which a company may not wish for its employees to be exposed, and exposing the company to potential additional liabilities. Also, many of the PHM may be obtained from multiple suppliers.

In today's world, there is a major push to buy products that are environmentally friendly, i.e., they do not produce as many harmful effects on the environment as similar products have in the past. Such products generally have a lower level of toxicity and thus, are also less harmful to people and animals that use and/are exposed to them. However, due to the volume of materials and complexity of analysis, it can be difficult to evaluate all the different products that are available in order to determine their effects on humans, animals and the environment in general.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 schematically illustrates an exemplary embodiment of a computer network that may be utilized within an enterprise that may be comprised of one or more sites, in accordance with various embodiments of the present invention;

FIG. 2 schematically illustrates an exemplary embodiment of a server that may be utilized within an enterprise that may be comprised of one or more sites, in accordance with various embodiments of the present invention;

FIG. 3 is a flowchart illustrating a process for creating a database of products, in accordance with various embodiments of the present invention;

FIG. 4 is a flowchart illustrating a process for obtaining information relating to the products from the database, in accordance with various embodiments of the present invention;

FIG. 5 illustrates an exemplary webpage for requesting information from the database, in accordance with various embodiments of the present invention;

FIG. 6 illustrates an exemplary webpage for displaying information comparing products from the database, in accordance with various embodiments of the present invention;

FIG. 7 illustrates an exemplary webpage providing a scorecard for a product, in accordance with various embodiments of the present invention;

FIG. 8 illustrates an exemplary webpage of scorecard details, in accordance with various embodiments of the present invention; and

FIG. 9 illustrates an exemplary webpage listing ingredients for a product, in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide methods and systems for screening of products, especially those with ingredients that may be toxic and/or otherwise harmful to people, animals and the environment in general.

Various embodiments of the present invention will be described herein with respect to management and procurement of PHM for clarity and simplicity. However, those skilled in the art will understand that the present invention may be applicable for the management and procurement of other types of materials, both chemical and non-chemical in nature.

The term PHM as used herein refers to a broad range of materials that may raise health, safety and/or environmental issues, including in particular those, which usage requires the maintenance of corresponding material safety data sheets (MSDS). Examples of such materials include, but are not limited to, the materials regulated by e.g. the U.S. Occupational Health and Safety Administration (OSHA) or the Environmental Protection Agency (EPA) of U.S. Government.

An MSDS of a PHM generally specifies the constituents (chemical make-up), first-aid procedures, special handling, storage, fire fighting procedures of the PHM. Not only the special handling and storage procedures have to be followed, the MSDS data must be updated and kept current by the organization using the materials.

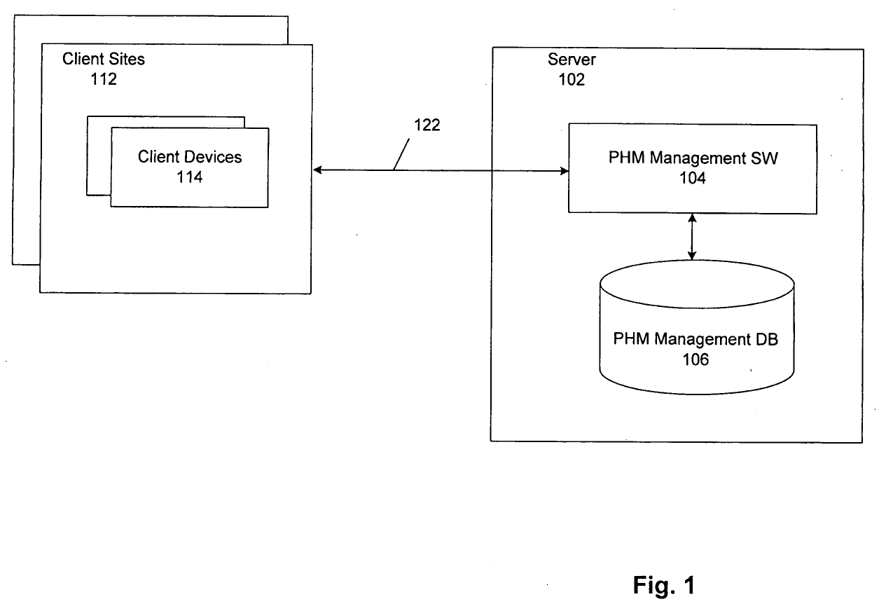

Referring now to FIG. 1, an overview of the present invention, in accordance with various embodiments, may be described. As illustrated, for the embodiments, server 102 is endowed with PHM Management Software 104, which is adapted with functions to provide guidance to client sites. In particular, as will be described in more detail below, PHM Management Software 104 is adapted to provide client sites 112 with summary data relating to PHM management and procurement issues.

For the various embodiments, server 102 is also provided with PHM database 106 having data of the clients. In alternate embodiments, PHM database 106 may be remotely disposed away from server 102 instead.

In various embodiments, PHM Management Software 104 presents summary data in various forms, such as, for example, tables, scorecards, graphical form, etc. on client devices 114. In particular, for the various embodiments, PHM Management Software 104 presents the summary data in the form of web pages. That is, server 102 is further endowed with a web server and various communication interfaces, whereas client devices are endowed with a browser and corresponding communication devices.

In other embodiments, the summary data may be presented in other formats, e.g. as an attachment to electronic communications, as printed mailings, and so forth.

For the various embodiments, client devices 114 are communicatively coupled to servers 102 via network connections 122 over a number of private and/or public networks, including, but not limited to, the Internet. The communications between client devices 114 and server 102 may be conducted in accordance with one of a number of messaging protocols, including but are not limited to, e.g., the HTTP protocol (HTTP=Hypertext Transmission Protocol).

Except for PHM Management Software 104, PHM Database 106, server 102 and client devices 114 represent a broad range of such elements known in the art, or to be designed (as long as they are consistent with the teachings of the present invention). Accordingly, except for PHM Management Software 104, and an example of server 102, PHM Database 106, client devices 114 and coupling 122 will not be further described.

While for ease of understanding, server 102 is “singularly” illustrated, in various embodiments, server 102 may be a single computing device, a cluster of tightly coupled computing devices, or networked computing devices.

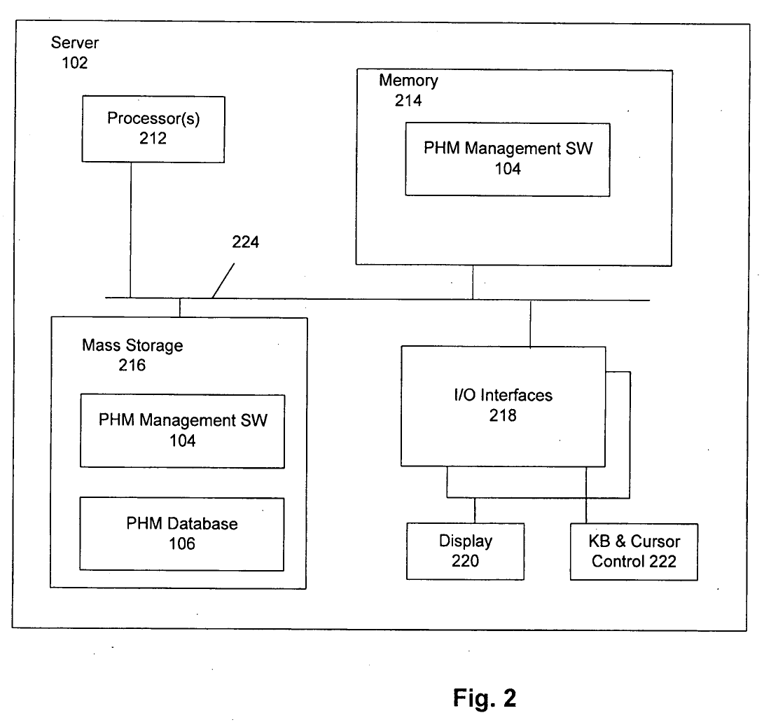

FIG. 2 illustrates an example implementation of server 102 of FIG. 1, in accordance with various embodiments of the present invention. As illustrated, server 102 includes digital computing processor 212, memory 214 coupled to each other via bus 224. Further, device 212 includes mass storage device 216, I/O interfaces 218, and a number of I/O devices coupled to each other and the earlier described elements as shown. Memory 214 and mass storage device 216 include in particular, a transient and a persistent copy of PHM Management Software 104 respectively. Mass storage device 216 further includes PHM database 106. The I/O devices include in particular, display 220 and keyboard/cursor control 222.

In various embodiments, processor 212 may be any one of a number of microprocessors known in the art, or to be designed (as long as they are consistent with the teachings of the present invention), including but are not limited to, the processors available from Intel Corp., of Santa Clara, Calif.

Memory 214 may likewise be any one of a number of volatile storage known in the art or to be designed (as long as they are consistent with the teachings of the present invention), including but are not limited to, the volatile storage available from Kingston Technology of Fountain Valley, Calif. Mass storage device 216 may likewise be any one of a number of non-volatile storage known in the art or to be designed (as long as they are consistent with the teachings of the present invention), including but are not limited to, the non-volatile disk storage available from Seagate of City, Calif.

In various embodiments, I/O interfaces 218 include a communication interface for coupling server 102 to client devices 114. The communication interface may be a wire based or wireless interface, coupling server 102 to devices 114 via a wired/wireless local/wide area network. An example of a suitable wired network interface includes but is not limited to an Ethernet interface, and an example of a suitable wireless network interface includes but is not limited to an IEEE 802.11b (working group) network interface.

Except for PHM Management Software 104 (described further herein), and the manner these elements are employed, each of these elements represents a broad range of the corresponding element known in the art or to be designed, consistent with the teachings of the present invention. The elements perform their conventional functions, i.e. processing, storage, reading, displaying, and so forth.

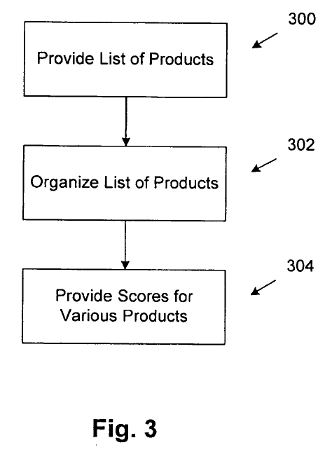

Referring to FIG. 3, in accordance with various embodiments of the present invention, PHM Management Software 104 may be furthered described. At block 300, a list of products may be provided to PHM Management Database 106 by one or more companies. The companies may be in the form of manufacturers or suppliers of various products such as, for example, cleaners, polishes, solvents, adhesives, paint, etc. Many of these products may include potentially hazardous materials (PHM). These suppliers may access the PHM Management Database 106 via client devices 114 located at client sites 112.

In accordance with various embodiments, the products may be organized at 302 based upon one or more factors that are based upon information relating to the products. These factors may include, for example, the type of product, the company or supplier, item content such as, for example, ingredients/chemicals/potentially hazardous materials, etc. Information relating to the products may be provided by the suppliers themselves. In accordance with various embodiments, the Chemical Abstracts Service (CAS) number for the product (if the product has one or many) may be used to determine the makeup of the various products and thereby provide the ingredients for the products. In addition, the products may be organized by their CAS numbers. In addition to the ingredient list and/or CAS number, information relating to other factors that may be deemed important to various customers may also be included. For example, a globally harmonized system (GHS) category for each product may be included in the PHM Management Database. For example, a product may be listed within the GHS category of “acute toxicity in humans.” Additionally, various other categories for a product may be included. For example, a paint product may also include information relating to dry time, toxicity, sheen, water resistance, etc.

In accordance with various embodiments, at 304, based upon the various pieces of information, ingredients, chemicals, potentially hazardous materials, etc., scores may be provided for various products. These scores may be based on various tests such as, GHS scoring, Environmental Protective Agency (EPA) scoring, tests provided by the manager or host of PHM management database 106, etc. In accordance with various embodiments, the score that is provided to various products may be either a pass or fail score, or may have a numerical value. The tests may be based upon either a “less is better” or a “more is better” scenario as desired and depending what is being tested. These values may be weighted based on priority concerns.

In accordance with various embodiments of the present invention, a numerical score may be assigned to a product based upon a first criterion or based upon a test performed on the product. In accordance with various embodiments, other scores may be assigned to products based upon other criterion and tests and thus, products may have one or more scores. In accordance with various embodiments of the present invention, examples of criterion include a level of toxicity and/or environmental effect.

In accordance with various embodiments of the present invention, the level of toxicity for products is generally based upon the hazards that could lead to cancer, reproductive and other health risks. One or more data sources may be used to provide the level of toxicity. Examples include the International Agency for Research on Cancer (IARC), California Proposition 65, National Toxicology Program (NTP), Hazardous Materials Identification System (HMIS), and the European Union Annex List. Generally, in accordance with various embodiments of the present invention, a point system may be provided for the toxicity ranking, wherein higher points mean that a particular product is more hazardous. Additionally one or more data sources may be utilized to quantify the environmental effect. Examples include Clean Air Act—Hazardous Air Pollutants (CAA HAPS), Clean Air Act—Ozone Depleting Substances (CAA ODS), Resource Conservation and Recovery Act—Hazardous Waste (RCRA), and European Union Annex List. Generally, in accordance with various embodiments of the present invention, a point system may be provided for environmental effect ranking, wherein higher points mean that a particular product has a more adverse environmental effect.

Thus, the PHM Software 104 may organize products within PHM Management Database 106 based upon one or more of the supplier name, the product name, the product type, the CAS number, ingredient/chemical/PHM list, etc. The PHM Software 104 may also provide information relating to scores for the various products and may also compare products based upon such scores, the presence of various ingredients/chemicals/PHMs, uses, etc.

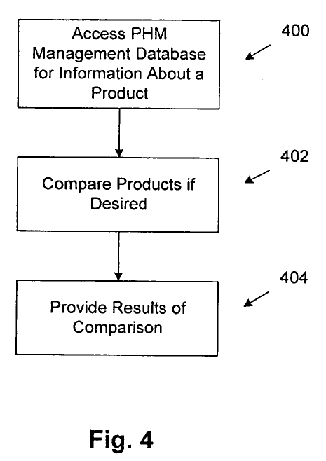

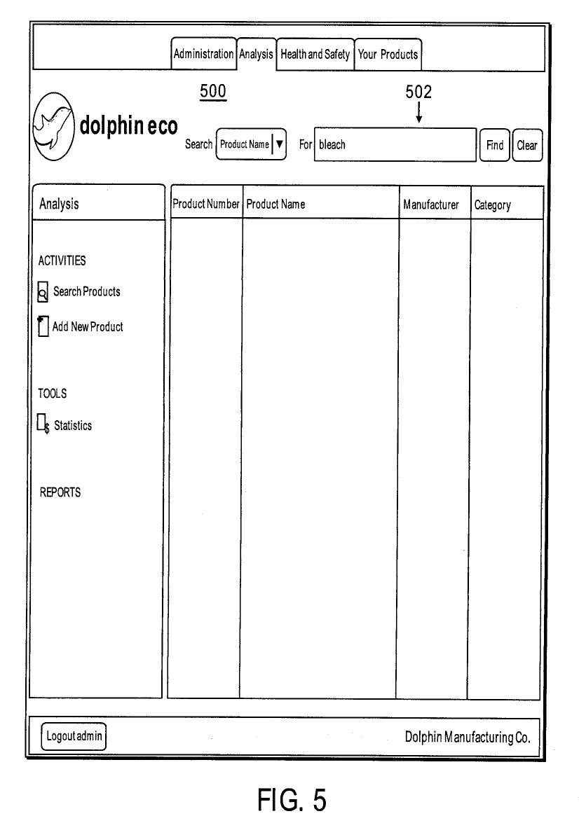

Referring to FIG. 4, use of the PHM Software 104 and the PHM Management Database 106 by customers or clients may be further described. A customer located at a client site 112 and including a client device 114 may access the PHM Management Database 106 at 400. A customer may be searching for information relating to a product that it either already possesses or that it wishes to obtain. For example, the customer may wish to obtain information regarding bleach products. The customer may access, via its client device 114, the PHM Management Database 106 in the form of a webpage 500, an example of which is illustrated in FIG. 5. By entering bleach into the web page at 502, the customer may be provided information pertaining to bleach products by the PHM Management Database 106. The information may include one or more of the pieces of information previously discussed. In accordance with various embodiments, information may also be provided to the customer relating to environmental concerns, toxicity to humans, sustainability issues, etc. Additionally, scores relating to various evaluations of bleach products may also be provided to the customer. PHM Management Software 104 may compare one or more pieces of information for the bleach products, for example, GHS category scores, various product evaluations, etc. and provide results of the comparison. In accordance with various embodiments, the comparison may have already been performed or the results may have been provided to the PHM management database 106 and thus, PHM management software 104 may simply retrieve the results from the PHM management database 106 and provide the results to the customer.

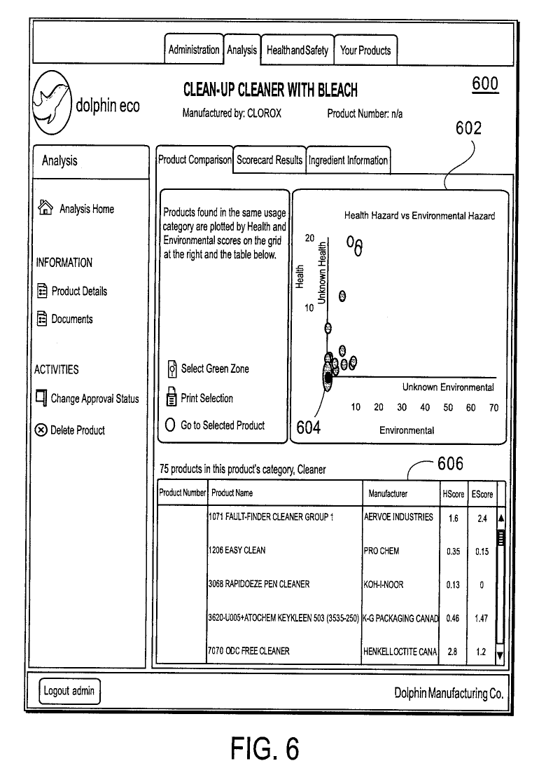

FIG. 6 illustrates an example webpage 600 that may illustrate results of a comparison of products. As may be seen, the bleach products are being evaluated based upon health hazard vs. environmental hazard. In this example, the customer has selected a product from Clorox in the form of a clean-up cleaner with bleach. In accordance with various embodiments, a graph 602 is provided that compares the results of the Clorox product, illustrated at 604, with various other cleaners that include bleach. Table 606 lists the various products and their scores.

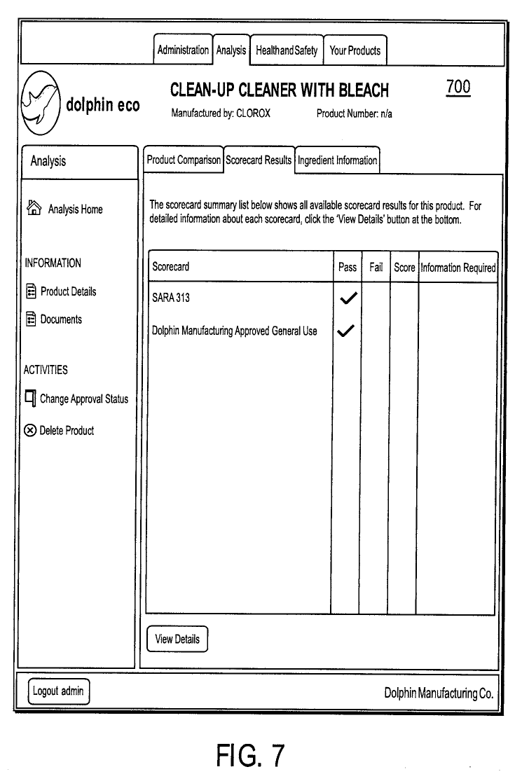

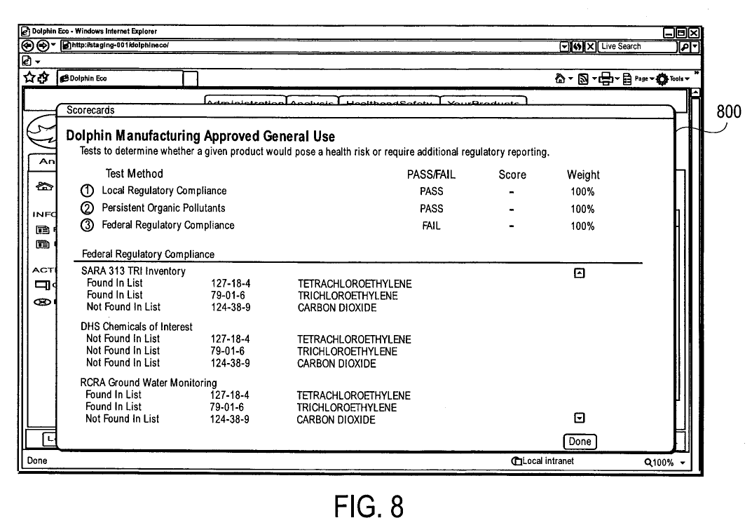

Referring to FIG. 7, in accordance with various embodiments, information and/or scores relating to a product may be provided to the customer in the form of a scorecard 700. In accordance with various embodiments, the scorecard 700 may be provided for a product based upon the scores. In accordance with various embodiments, the scorecard 700 may provide and/or organize information outlined above and may also allow one to see what other products, if any, against which the product was compared. Additionally, in accordance with various embodiments, the scorecard may weight various scores for a product and provide an overall score for the product. In accordance with various embodiments, a product may pass or fail based upon the overall score. In the example illustrated in FIG. 7, test results for a product from Clorox in the form of a clean-up cleaner with bleach are provided. In accordance with various embodiments, further details of the scorecard 700 may be interactively selected for display by a user. FIG. 8 illustrates an exemplary webpage 800 that provides examples of further details of the scorecard 700 that may be provided, in accordance with various embodiments of the present invention.

Referring to FIG. 4 once again, in accordance with various embodiments, the customer may also select another type of cleaner with which to compare the Clorox cleaner at 402. PHM Management Software 104 may then compare one or more pieces of information for the Clorox cleaner and the other type of cleaner such as, for example, GHS category scores, various product evaluations, etc. and provide results of the comparison. In accordance with various embodiments, the comparison may have already been performed or the results may have been provided to the PHM management database 106 and thus, PHM management software 104 may simply retrieve the results from the PHM management database 106 and provide the results to the customer. As previously noted, FIG. 6 illustrates an example webpage 600 that may illustrate results of a comparison of products.

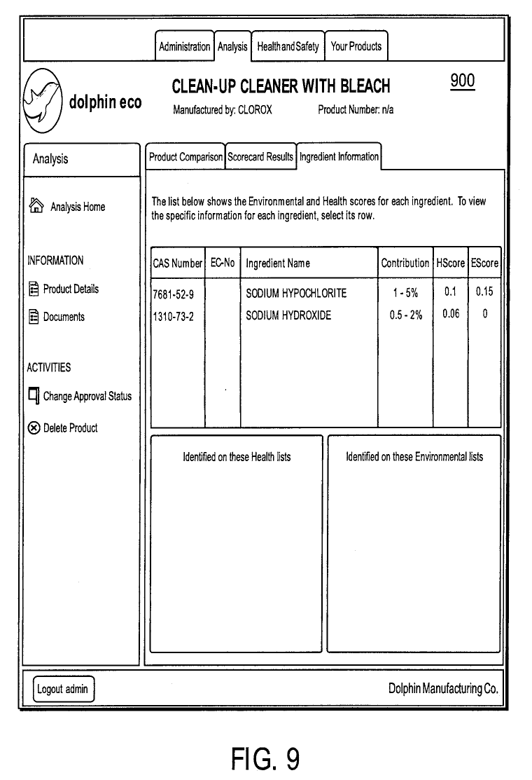

In accordance with various embodiments, suppliers may list their products and will generally include one or more ingredients, if not the entire list of ingredients. FIG. 9 illustrates an example of a webpage 900 that lists ingredients for the Clorox cleaner. However, the supplier need not list the exact composition of the product for access by customers. Thus, trade secrets of suppliers may be maintained.

In accordance with various embodiments, as is known in the industry, access to the PHM Management Database 106 by suppliers and customers may be protected by various security measures such as, for example, passwords.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments illustrated and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. An electronic method for facilitating screening of items based upon item content, the method comprising:
providing a database of items, the database including information relating to item content for each item;
providing an evaluation of at least one item based at least upon one piece of item content; and
providing a report pertaining to the at least one item based upon the evaluation.

2. The method of claim 1, wherein the evaluation is based upon at least one chemical ingredient of a respective item.

3. The method of claim 2, wherein the evaluation of the at least one chemical ingredient based upon at least one of toxicity, effect on environment and sustainability issues.

4. The method of claim 2, wherein the method further comprises providing a score for the at least one item is based upon the evaluation of the at least one chemical ingredient.

5. The method of claim 4, wherein providing a score for the at least one item comprises evaluating the at least one chemical ingredient based upon at least one of toxicity, effect on environment and sustainability issues.

6. The method of claim 5, wherein providing a score for the at least one item is based upon multiple chemical ingredients of a respective item and providing a score for each chemical ingredient.

7. The method of claim 4, further comprising comparing at least two items based upon each item's score.

8. The method of claim 4, wherein providing a report pertaining to the at least one item comprises indicating whether the at least one item passed a pre-determined criterion, the passing being based upon the evaluation of the at least one item.

9. The method of claim 1, wherein the providing a database of items comprises listing, for each item, at least one chemical ingredient.

10. The method of claim 9, wherein at least one item has multiple chemical ingredients listed.

11. The method of claim 9, wherein the evaluation is based upon at least one chemical ingredient of a respective item.

12. The method of claim 11, wherein the evaluation of the at least one chemical ingredient based upon at least one of toxicity, effect on environment and sustainability issues.

13. The method of claim 11, wherein the method further comprises providing a score for the at least one item is based upon the evaluation of the at least one chemical ingredient.

14. The method of claim 13, wherein providing a score for the at least one item comprises evaluating the at least one chemical ingredient based upon at least one of toxicity, effect on environment and sustainability issues.

15. The method of claim 13, wherein providing a score for the at least one item is based upon multiple chemical ingredients of a respective item and providing a score for each chemical ingredient.

16. The method of claim 13, further comprising comparing at least two items based upon each item's score.

17. The method of claim 13, wherein providing a report pertaining to the at least one item comprises indicating whether the at least one item passed a pre-determined criterion, the passing being based upon the evaluation of the at least one item.

18. A system comprising:
one or more storage devices including one or more databases adapted store a list of items, the list including information relating to item content for each item; and
one or more servers operatively coupled to the one or more storage devices, the one or more servers being configured to provide an evaluation of at least one item based at least upon one piece of item content and to provide a report pertaining to the at least one item based upon the evaluation.

19. The system of claim 18, wherein the evaluation is based upon at least one chemical ingredient of a respective item.

20. The system of claim 19, wherein the evaluation of the at least one chemical ingredient based upon at least one of toxicity, effect on environment and sustainability issues.

21. The system of claim 19, wherein the one or more servers are further configured to provide a score for the at least one item is based upon the evaluation of the at least one chemical ingredient.

22. The system of claim 21, wherein the one or more servers are configured to provide a score for the at least one item by evaluating the at least one chemical ingredient based upon at least one of toxicity, effect on environment and sustainability issues.

23. The system of claim 22, wherein the one or more servers are configured to provide a score for the at least one item based upon multiple chemical ingredients of a respective item and to provide a score for each chemical ingredient.

24. The system of claim 21, further wherein the one or more servers are further configured to compare at least two items based upon each item's score.

25. The system of claim 21, wherein the one or more servers are configured to provide a report pertaining to the at least one item by indicating whether the at least one item passed a pre-determined criterion, the passing being based upon the evaluation of the at least one item.

27. The system of claim 18, wherein the one or more servers are configured to provide the report in the form of a webpage.
